(19) United States
(12) Patent Application Publication
(10) Pub. No.: US 2009/0294336 A1
(43) Pub. Date: Dec. 3, 2009

(54) Fines separator and trap

(76) Inventor: Waleed Y. Jassim, Champaign, IL (US)

Correspondence Address: Waleed Y. Jassim, 1715 Lynwood Dr., Champaign, IL, 61821, US

(21) Appl. No.: 12/156,498

(22) Filed: Jun. 2, 2008

(51) Int. Cl. B07B 4/00; B32B 37/00; B65D 30/22

(52) U.S. Cl. 209/422; 156/73.4; 383/40

(57) ABSTRACT

A bag (600) comprises a storage region (630), a fines filter (635), and a fines trap (640). A plurality of chevron-like regions (620) that join the flat sides of the bag are spaced by a plurality of open regions (625). When a mixture of coarse (700) and fine (705) particles is stored in the bag, the fine particles, including fluids, gravitate toward the bottom of the bag and pass through the fines filter. Once in the trap, the fines are prevented from exiting the bag as its contents are dispensed. After separation, the fines can be dispensed from the bag by opening a seal (615) at the bottom of the bag. The bag can be made of materials including plastic, fabric, paper, metal, and the like.

### BACKGROUND

1. Field

The field is packaging, and in particular packages which separate smaller particles (fines) from the larger particles in a package.

2 Prior-Art Fines Filters

The following is a list of some prior art that presently appears relevant:

| | Kind | Issue or | Patentee |
|---|---|---|---|
| Patent or Pub. Nr. | Code | Pub. Date | or Applicant |
| 741454 | B1 | 1903-10-13 | Byar |
| 2970920 | B1 | 1961-02-07 | Forkner |
| 3159096 | B1 | 1964-12-01 | Tocker |
| 4503559 | B1 | 1985-03-05 | Warnke |
| 4963374 | B1 | 1990-10-16 | Brandel et al. |
| 4889619 | B1 | 1989-12-26 | Lynch |
| 5958483 | B1 | 1999-09-28 | Anders et al. |

Particulate materials, such as cold breakfast cereals, contain particles having a range of sizes, from very fine or dust like particles, to larger particles, which may be in flake, nugget, biscuit, toroid, worm, or other form. During shipping and handling, the larger particles often break into smaller particles, thus increasing the proportion of such smaller particles or fines. Many users and consumers of such particulate materials dislike the fines for various reasons, so that fine eliminators, separators, or filters have been devised and are well known.

For example, Byar shows a coal hod with a screen sieve for separating the dust or ashes from the large lumps of coal. Byar's hod comprises numerous pieces: a bucket, a hoop, a handle, a screen, and a flange, among others.

Forkner shows a simple food package with a perforated side wall so that the fines or powdered part can pass out through the perforations when desired. The fines are initially included with the contents of the package and remain contained therein until the user removes a covering strip. When the strip is removed, the fines pass out of the package through small openings, leaving the larger food components inside.

Tocker shows a bag for fruit with perforations at the bottom that are covered by a removable tape. The fruit in the bag can be manually squeezed, expressing its juice. When the tape is removed, juice from the fruit can pass out of the bag, leaving the fruit pulp behind. Like Forkner, Tocker's bag requires the user to remove a sealing strip in order to perform the bag's intended function.

Warnke shows a popcorn container comprising an outer and an inner bag. Both bags are made of a mesh. The inner bag has a coarser mesh to allow unpopped kernels (windows) to pass through to the outer bag. The outer bag is made of a fine mesh to enable users to see through it to confirm that the windows are passing through to the outer bag. Warnke requires two different bags in order to perform the separation function.

Brandel et al. show a popcorn bag with a screen extending across the bottom part for trapping windows. Brandel comprises two components: a bag and an insert affixed to the walls of the bag.

Lynch shows a cereal package with a fines trap at the bottom. The fines trap comprises a synclinal partition having a perforated central panel with two side ramps sloping up. Like Brandel, Lynch requires installation of the partition at the bottom of the package.

Anders et al show a cereal package having an outer bag with a smaller inner bag. The bottom of the inner bag has holes and is spaced from the bottom of the outer bag so that the fines, i.e. cereal crumbs, can fall through the holes and collect in the bottom of the outer bag. As with Warnke, Anders requires the use of a plurality of bags in order to form its function.

All of the above prior-art filtration or separation systems have one or more of the following disadvantages. Two components are required, i.e., inner and outer bags or an insert to an ordinary container is required or an adhesive strip covers a portion of the container and must be removed in order for the container to perform its function. All are relatively complex and elaborate and require installation of components on or within the container. None is sufficiently simple so that it can be readily incorporated in standard packaging.

### SUMMARY

In accordance with an aspect of one embodiment, a fines filter and trap comprises a simple modification to existing, standard package. In another aspect, a fines filter and trap is suitable for separating larger components from fines such as a liquid or a powder. In still another aspect, the fines filter and trap is incorporated into disposable packaging at little cost. In still another aspect, the apparatus that forms the fines filter and trap is incorporated into equipment that manufactures standard packaging, or adapted for aftermarket use to add the filter and trap to existing bags.

### DRAWING FIGURES

FIGS. 1A and 1B show front and side views of a prior-art plastic bag.

FIG. 2 shows a side view of a prior-art two-layer composite suitable for making a bag.

FIGS. 3A through 3C show a prior-art method for sealing two sides of a plastic bag together.

FIG. 4 shows an embossed wheel.

FIG. 5 shows the wheel of FIG. 4 being used to join predetermined regions in a bag.

FIGS. 6A and 6B respectively show side and front views of a bag according to one aspect of a preferred embodiment.

FIG. 7 shows the bag of FIGS. 6A and 6B in use as fines are sifted from coarse particles.

FIG. 8 shows the bag of FIG. 7 in the process of dispensing coarse particles after fines have been removed.

FIGS. 9 through 15 show alternative embodiments of the fines filter and trap.

### DRAWING FIGURE REFERENCE NUMERALS

100 Bag
101 Edge
102 Edge
103 Bottom
105 Seal
106 Sheet
107 Sheet
200 Bag material
205 Coating
300 Sheet
301 Sheet
305 Source
310 Source
315 Seal
400 Wheel
405 Shaft
415 Wheel
420 Shaft
600 Bag
601 Edge
602 Edge
605 Top
606 Seal
610 Bottom
615 Seal
620 Region or attachment
621 Section
622 Section
625 Region
630 Region
635 Region
640 Region
700 Particles
705 Fines
1300 Region
1500 Wall
1505 Wall

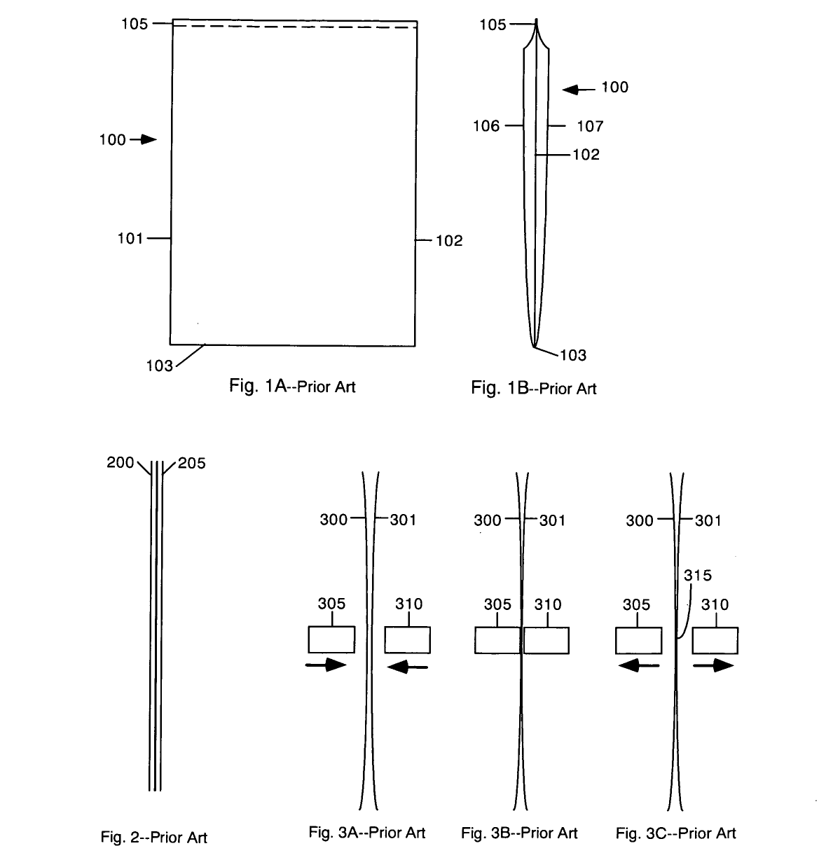

### Prior Art—Plastic Bags—FIGS. 1 through 3

Prior to discussing the aspects of the present fines filter and traps, a prior-art plastic bag is shown. FIGS. 1A and 1B respectively show front and side views of a prior-art plastic bag 100 comprising two sheets of material 106 and 107 that are joined at edges 101 and 102, and a bottom 103. The top of bag 100 is normally held open for filling, then closed with a seal 105 that prevents spilling of any contents (not shown). Such bags are well-known and made by many manufacturers. They are generally made of polyethylene, polyethylene terephthalate, polypropylene, acrylonitrile-butadiene-styrene, and other plastic materials.

FIG. 2 shows a side view of a piece of material 200 of a prior-art bag; the material optionally has a coating layer 205. Coating 205 can be used to bind the Coating 205 comprises a metal film, a plastic material, or an adhesive. If coating layer 205 is an adhesive, it can be pressure, heat, or light-activated so that two layers of bag material 200 can be joined by one or two layers of coating 205, as described below in connection with heat-sealing.

FIG. 3A shows two sheets of plastic film 300 and 301 about to be fused together using a prior-art sealing method. Sheets 300 and 301 are brought into close proximity. A first thermal source 305 is positioned on the left-hand side of sheet 300 and a second thermal source 310 is positioned on the right-hand side of sheet 301. Source 305 supplies heat at a temperature sufficient to soften sheets 300 and 301. Source 310 can be a heat source, an insulating material capable of containing heat applied by source 305 and transmitted through sheets 300 and 301, or a cooling source depending on the nature of the bond desired, as is well-understood by those skilled in the art of heat sealing plastic films. FIG. 3B shows sheets 300 and 301 being pressed between sources 305 and 310. Heat supplied by sources 305 and 310 causes local softening of sheets 300 and 301. Sufficient time is allowed to fuse sheets 300 and 301 together. The duration of the contact between sheets 300 and 301 is a function of the temperatures of sources 305 and 310.

In FIG. 3C, sources 305 and 310 have been removed and a fused area 315 exists where sheets 300 and 301 have been bonded together.

Instead of supplying heat, one or both of sources 305 and 310 can seal the region between them using pressure alone, ultrasound, infrared light, pulsed laser light, and the like. One or both of sources 305 and 310 can be a wheel, rod, wire, clamp, or a die.

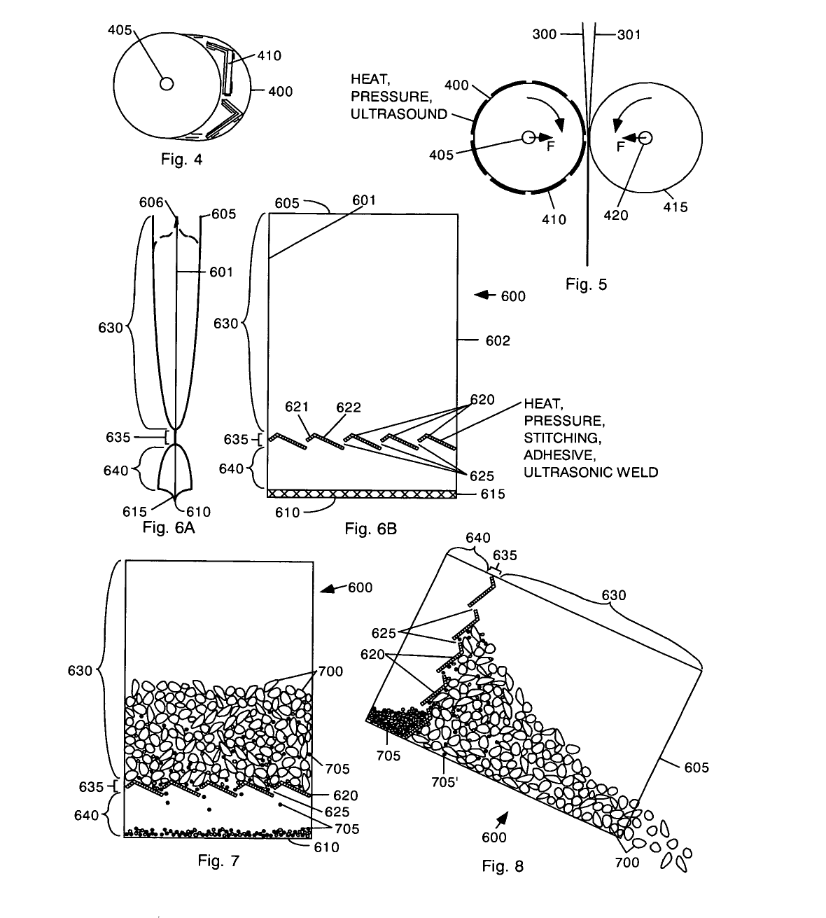

### First Embodiment—Description—FIGS. 4 through 6

FIG. 4 shows an embossing wheel 400 for joining the two sides of bag 600 to form a series of joined regions 620 (FIG. 6). Wheel 400 has raised, chevron or other shaped regions projecting outward from its surface. Wheel 400 turns on a shaft 405 and is rotated by manual or other mechanical means such as a motor or other motive force such as a hand crank or an electric, pneumatic, or hydraulic motor (not shown). The diameter and width of wheel 400 are typically 10 cm and 2 cm, respectively, although other sizes can be used. Wheel 400 can be made from metal, ceramic, composite materials, glass, or even wood.

FIG. 5 shows the wheel of FIG. 4 in use. The facing sides, sheets 300 and 301, of a bag 600 (FIG. 6) pass between embossing wheel 400 and a second, similarly-sized but plain (non-embossed) wheel 415. Wheels respectively 400 and 415 rotate on shafts 405 and 420 under the urging of a. One or both of wheels 400 and 415 are heated or subjected to other sealing energies such as ultrasound, or pressure. Wheels 400 and 415 are urged together with a force, F, which, when combined with the proper level of sealing energy, is sufficient to cause the joining of sheets 300 and 301 only in regions 410.

FIGS. 6A and 6B, respectively, show side and front views of a bag according to one aspect of the present embodiment. Bag 600 has a top 605 which can be optionally closed so as to form a seal 606. Top 605 is normally open for dispensing and closed for storage of the bag's contents. Bag 600 further includes a bottom 610 with a closure seal 615, and first and second side edges 601 and 602, respectively. Seals 606 and 615 can be permanent or recloseable. Many bag designs incorporate seals such as seal 615, while other designs avoid use of such a seal.

A series of joined regions or attachments 620 traverse the width of bag 600. Attachments 620 are formed by the wheel of FIG. 4 in the process of FIG. 5. Regions 620 comprise at least two linear sections 621 and 622 that are not collinear. Regions 620 are interspersed with and separated by not-joined or open regions or passageways 625 and extend in a line all across the full width of bag 600. Regions 620 and 625 can overlap in order to facilitate flow of fines 705 while blocking passage of coarse particles 700. As explained above, sides 300 and 301 of bag 600 are sealed together at regions 620, and not sealed together, i.e. the sides are free to part, in regions 625. Thus bag 600 comprises three regions: a storage region 630 in the upper portion near the top, a filter region 635 which includes attachments 620 beneath region 630, and a fines trap 640 in the lower portion located beneath region 635.

Regions 620 and 625 are preferably sized to accommodate predetermined contents of bag 600. Regions 625 are sized to pass fines 705 (FIG. 7) but not coarse particles 700. If the user desires to separate small to larger fines, regions 625 must be made relatively large, while if the user desires to separate just small fines, obviously regions 625 should be made smaller. Fines 705 can include water or other fluids. In the case of fluids, regions 625 can range in size from just large enough to pass a fluid, to just less than that of coarse particles 700.

In the case of textile bags, for example burlap bags, regions 620 and 625, seal 615, and closure 606 can be formed by stitching the sides of the bags together. In this case regions or attachments 620 would have a spot like shape.

Bag 600 is normally made of polyethylene plastic, but can be made of other plastics, textiles, metal, wood, glass, or composites. Bag 600 can be coated internally and externally with metal films, thermally-activated adhesives, bactericides, and other special-purpose materials. The size of bag 600 can range from a few centimeters to a meter or more, depending upon the materials to be stored. The wall thickness of bag 600 is typically 0.05 mm, although it can be thicker or thinner as required. Bag 600 can be transparent, translucent, opaque, patterned, decorated, smooth, or embossed.

As stated regions 620 are chevron-shaped in the example shown, but can have other shapes, such as spots, line segments, angles with equal sides with corners facing up, etc.

### First Embodiment—Operation—FIGS. 7 and 8

FIG. 7 shows bag 600 partially filled with coarse and fine materials, 700 and 705, respectively. Bag 600 is initially empty. A mixture of fine and coarse particles 700 and 705 is first poured into storage region 630 of bag 600 or the particles can initially all be large and fines 705 can accumulate through handling and shipping as coarse particles 700 break down. Bag 600 is optionally sealed at this time. When bag 600 is oriented vertically as shown, fines 705 may already be present or may be created by vibrations from various sources such as shipping and handling, and due to such vibrations will gravitate downward in the spaces between individual pieces of coarse materials 700. When fines 705 reach filter region 635, they sift through openings 625 between embossed regions 620, and collect in trap region 640.

FIG. 8 shows the dispensing of particles 700 from bag 600. Top 605 of bag 600 is opened and bag 600 is tilted until materials 700 flow past top 605 and out of bag 600. Fines 705 that have sifted through openings 625 between embossed regions 620 are trapped in region 640. A few fines 705′ that have not been sifted into region 640 can escape with particles 700. However if there has been sufficient time and sifting action, most fines 705 will remain in region 640. Since the corners of regions 620 face upwardly, the fines will be able to move more easily from region 630 to region 640 than vice versa.

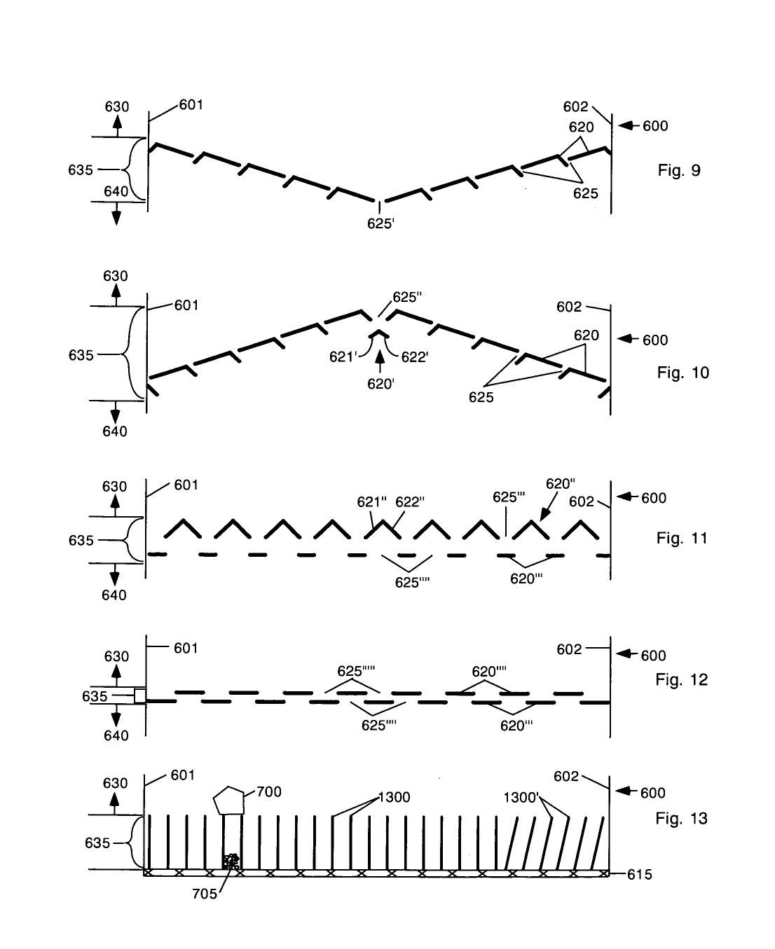

### Alternative Embodiments—Description and Operation—FIGS. 9 through 15

Other filter and trap configurations are contemplated. The correct configuration must be determined for a particular combination of larger particles and fines.

FIGS. 9-12 show alternative arrangements and shapes of regions 620 and 625. Storage and trap regions 630 and 640, respectively, lie above and below filter region 635.

In FIG. 9 regions 620 are arranged in a synclinal formation having regions 620 and openings 625 with an additional opening 625′ in the center.

FIG. 10 shows an inverted or anticlinal version of the formation in FIG. 9 with a modified opening 625″ and a modified region 620′ in the center. Region 620′ comprises two linear portions 621′ and 622′ joined in the anticlinal configuration.

FIG. 11 shows an alternative arrangement with joined regions 620″ and 620′″ and spaced regions 625′″ and 625″″. In this aspect, joined regions 620′″ comprise two linear sections 621″ and 622″ joined in an inverted-V configuration. Straight joined sections 620′″ lie directly beneath open regions 625′″.

FIG. 12 shows a filter design in which segments 621″ and 622″ are replaced by horizontal segments 620″″ and spaces 625′″″ that are interspersed as shown. Larger particles (not shown) are blocked by regions 620′″ and 620″″. Fines (not shown) enter region 640 via a labyrinthine path starting at region 625′″″ and passing through region 625″″.

FIG. 13 shows an alternative filter arrangement. A series of parallel, linear regions or attachments 1300 extend up from the bag's bottom and join the front and back sides of bag 600, thereby forming a bottom filter or trap section 635. The separation between adjacent regions 1300 is closer than the size of coarse particles 700 so that the coarse particles cannot pass between regions 1300, while fines are able to enter the spaces between regions 1300 and fall to the bottom of bag 600. Fines 705 fall to seal 615 at the bottom of bag 600. When bag 600 is tilted to dispense particles 700, fines 705 remain between regions 1300 until bag 600 is tilted to an angle greater than 90 degrees from its normal upright position. At this angle most, if not all, of particles 700 will have been dispensed. In the arrangement shown, since attachments 1300 extend up from the bag's bottom, no trap section 640 is present; i.e. regions 1300 extend up from seal 615. However, a trap section 640 can be included, as in the previous designs. Additionally, regions 1300 can be oriented at any angle with respect to seal 615. For example, regions 1300′ are oriented at an angle other than 90 degrees with respect to seal 615. Such variations in orientation can help ensure that fines 705 remain trapped when bag 600 is tilted for pouring. The height of sections 1300 can be determined by the volume of fines to be trapped.

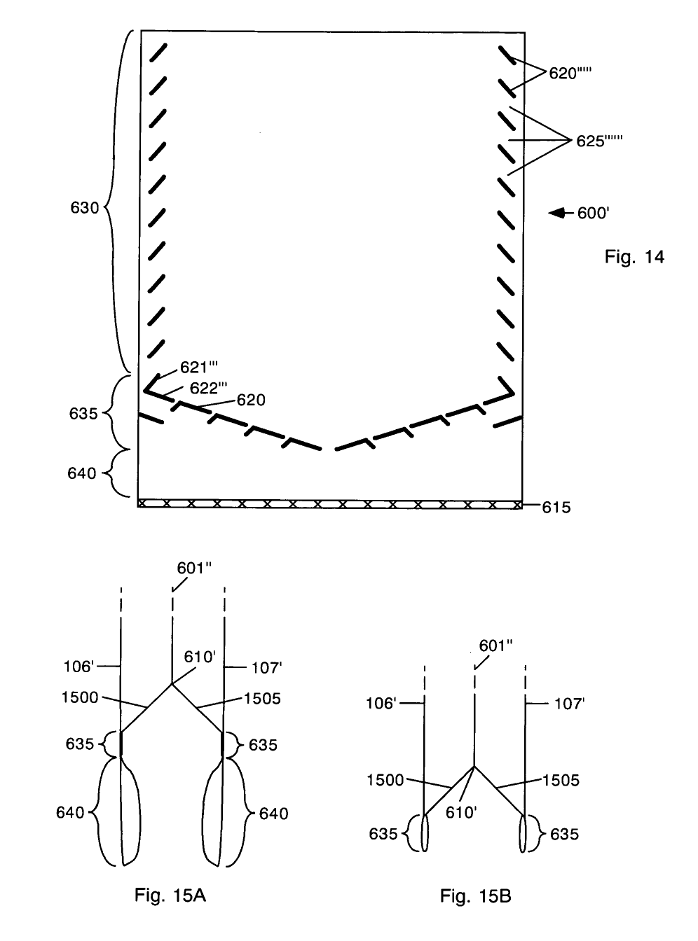

FIG. 14 shows an alternative bag having a bottom seal 615, and additional joined regions 620′″″, and spaced regions 625″″″ located at the vertical edges of bag 600′. Additional regions 621′″ and 622′″ form a transition between regions 620′″″ and 620. This bag design is especially useful in separating fruit pieces or wet or washed vegetables and water, for example. Although water can flow downward between wet contents, it can also flow in a generally horizontal direction along the surface of the contents. When this lateral flow reaches spaces 625″″″, it is able to quickly flow downward along the inside of edges 106 and 107 and into region 640.

FIGS. 15A and 15B show side views of alternative bags having a W-shape with two bottom portions. Instead of a single filter and trap at the bottom of the bag, two filter and trap assemblies are present, one on each side of the bag. This configuration is useful in cases where the bag must stand up without external support. FIG. 15A shows a bag similar to those shown in FIGS. 6A through 12. Outer side walls 106′ and 107′ extend downward from the top of the bag (not shown in this figure) to filter portions 635, and finally to trap portions 640. Bottom 610′ of the bag is connected to the upper end of the left-hand filter 635 by portion 1500, and right-hand filter 635 by 1505, respectively. Edge 601′ and matching edge 602′ (not shown in this figure) extend upward from bottom 610′, thereby forming a W-shape at the bottom of the bag.

FIG. 15B shows a bag of similar construction to that in FIG. 15A, except the fines filter and trap are combined, as in FIG. 13. In a further aspect of this embodiment, a bag comprises filter 635 and trap 640 (shown in FIGS. 6 through 12) on one leg of the W-shape, while the other leg incorporates combined filter and trap section 635 (shown in FIG. 13).

### CONCLUSION, RAMIFICATIONS, AND SCOPE

The embodiments shown of my fines separator and trap for bags provide several useful and advantageous features. For example, fines are sequestered at the bottom of the bag. Once separated from the coarser particles, the fines are trapped by the V-shaped regions in a way that prevents their rejoining the coarser particles as the bag is tilted, thereby allowing only the coarse particles to be dispensed from the bag. The open regions of the filter portion of the bag can range in size from fluid molecules to a size just less than that of the coarse particles. This makes the bag useful in separating water and juices from fruit, cereal fines from cereal, sand from rocks, and so forth.

While the above description contains many specificities, these should not be considered limiting but merely exemplary. Many variations and ramifications are possible. For example, if it is desired to mix fines with coarse particles, the mixture can be poured into the bag, and then the bag can be laid on its side until the two components are to be separated. Instead of relying on ambient vibration to cause fines to gravitate to the trap, forced vibration can be used. Instead of flexible bags, the sides of rigid containers can be separated by spacers that form the joined regions and inter-spaces. When it is desired to dispense the fines and not the coarse particles, the bottom of the bag can be opened after separation. The bag can be operated at low or high temperatures. Air or another gas can flow through the bag from top to bottom in order to hasten separation or dry fruit contained therein. Air or another gas can intermittently flow from bottom to top in order to agitate all particles while encouraging separation. More than one filter section can be used, thereby permitting gradation in the size of fines trapped beneath each section.

While the present system employs elements which are known to those skilled in the art of water leak detector and alarm design, it combines these elements in a novel way which produces new results not heretofore discovered. Accordingly the scope should be determined, not by the embodiments illustrated, but by the appended claims and their legal equivalents.

1. A fines separator and trap, comprising:
a bag having first and second sides, an upper portion and a lower portion,
one or more joined regions or attachments between said first and second sides, said joined regions comprising a plurality of non-collinear sections,
one or more open regions between said first and said second sides, said open regions being of a predetermined size and interspersed between said joined regions, said joined and said open regions extending across the full width of said bag,
wherein said joined regions and said open regions form a boundary between said upper and said lower portions,
whereby when a mixture of coarse particles greater than said predetermined size and fine particles less than said predetermined size is introduced into or present in said upper portion of said bag, only said fine particles pass through said open regions into said lower portion of said bag.

2. The separator and trap of claim 1 wherein said lower portion of said bag further includes a seal selected from the types consisting of recloseable and permanent.

3. The separator and trap of claim 1 wherein said bag is made from materials selected from the group consisting of plastic, metal, textiles, paper, wood, glass, or composites.

4. The separator and trap of claim 1 wherein the shape of said boundary is selected from the group consisting of linear, synclinal, and inverted-synclinal.

5. The separator and trap of claim 1 wherein said joined regions are created by means selected from the group consisting of heat, pressure, stitching, adhesive, and ultrasonic welds.

6. The separator and trap of claim 1 wherein the shape of said attachments is selected from the group consisting of chevrons, spots, line segments, and angles with equal sides with corners facing up.

7. A method for separating fines and coarse particles, comprising:
providing a bag having first and second sides, an upper portion and a lower portion,
providing one or more joined regions between said first and second sides, said joined regions comprising a plurality of non-collinear sections,
providing one or more open regions between said first and said second sides, said open regions being of a predetermined size and interspersed between said joined regions, said joined and said open regions extending across the full width of said bag,
wherein said joined regions and said open regions form a boundary between said upper and said lower portions,
placing a mixture of said fines and said coarse particles, said coarse particles being larger than said predetermined size and fine particles being smaller than said predetermined size, whereby only said fine particles pass through said open regions into said lower portion of said bag
thereby separating said fines and said coarse particles.

8. The method of claim 7, wherein said lower portion of said bag further includes a seal selected from the types consisting of recloseable and permanent.

9. The method of claim 7, wherein said bag is made from materials selected from the group consisting of plastic, metal, textiles, wood, glass, paper, or composites.

10. The method of claim 7, wherein the shape of said boundary is selected from the group consisting of linear, synclinal, and inverted-synclinal.

11. The separator and trap of claim 7, wherein said joined regions are created by means selected from the group consisting of heat, pressure, adhesive, and ultrasonic welds.

12. The separator and trap of claim 7 wherein the shape of said attachments is selected from the group consisting of chevrons, spots, line segments, and angles with equal sides with corners facing up.

13. A method for making a fines separator and trap, comprising:
providing a first wheel having a plurality of joined patterns, each pattern comprising a plurality of non-collinear lines, said patterns interspersed with spaces of a predetermined size,
providing a second wheel with a flat surface,
providing a bag comprising two sides,
urging said patterns into contact with the exterior of said bag at said sides of bag while said wheel is turned and moves relative to said sides between said first and said second wheels,
thereby joining said sides of said bag in said patterns and said spaces to complete said separator and said trap.

14. The method of claim 13 wherein said first wheel is supplied with energy selected from the group consisting of heat and ultrasound.

15. The method of claim 13 wherein said joined regions are created by means selected from the group consisting of heat, pressure, adhesive, stitching, and ultrasonic welds.

16. A fines separator and trap, comprising:
a bag having first and second sides, first and second edges, an upper portion and a lower portion,
one or more joined regions between said first and second sides, said joined regions comprising a plurality of parallel linear sections,
one or more open regions between said first and said second sides, said open regions being of a predetermined size and interspersed between said joined regions,
wherein said joined regions and said open regions form a boundary between said upper and said lower portions, said boundary extending from said first edge to said second edge of said bag,
whereby when a mixture of coarse particles greater than said predetermined size and fine particles less than said predetermined size is introduced to said upper portion of said bag, only said fine particles pass through said open regions into said lower portion of said bag.

17. The fines separator and trap of claim 16 wherein said parallel linear sections are oriented at angles with respect to said edges, said angles selected from the group consisting of acute, obtuse, and right angles.

18. The fines separator and trap of claim 16 wherein said lower portion of said bag has zero extent in a direction parallel to said edges of said bag.

19. The separator and trap of claim 16 wherein said lower portion of said bag further includes a seal selected from the types consisting of recloseable and permanent.

20. The separator and trap of claim 16 wherein said bag is made from materials selected from the group consisting of plastic, metal, textiles, wood, glass, paper, or composites.

21. The separator and trap of claim 16 wherein the shape of said boundary is selected from the group consisting of linear, synclinal, and anticlinal.

22. The separator and trap of claim 16, wherein said joined regions are created by means selected from the group consisting of heat, pressure, stitching, adhesive, and ultrasonic welds.

23. A bag comprising:
first and second sides, a single upper portion and two bottom portions, each of said sides incorporating a fines separator and trap separating each of said top and bottom portions, said separator and traps comprising one or more joined regions or attachments between said first and second sides and one or more open regions between said first and said second sides, said open regions being of a predetermined size and interspersed between said joined regions, said joined and said open regions extending across the full width of said bag wherein said joined regions and said open regions form a boundary between said upper and said lower portions,
said first and second sides of said bag being joined at the lower ends of said upper portions, thereby giving said bag a W-shape,
whereby said bag is capable of standing upright without external support so that when a mixture of coarse particles greater than said predetermined size and fine particles less than said predetermined size is introduced into or present in said upper portion of said bag, only said fine particles pass through said open regions into said lower portions of said bag.
